(19) United States
(12) Patent Application Publication
(10) Pub. No.: US 2017/0082984 A1
(43) Pub. Date: Mar. 23, 2017

(54) ELECTRONIC CONTROL DEVICE

(71) Applicant: Hitachi Ltd., Chiyoda-ku, Tokyo (JP)

(72) Inventors: Tatsuya HORIGUCHI, Tokyo (JP); Teppei HIROTSU, Tokyo (JP); Hiroshi IWASAWA, Tokyo (JP)

(73) Assignee: Hitachi Ltd., Chiyoda-ku, Tokyo (JP)

(21) Appl. No.: 15/311,678

(22) PCT Filed: May 7, 2015
(86) PCT No.: PCT/JP2015/063162

§ 371 Date: Nov. 16, 2016

(30) Foreign Application Priority Data
May 20, 2014 (JP) 2014-103911

(51) Int. Cl. G05B 11/36

(52) U.S. Cl. CPC G05B 11/36

(57) ABSTRACT

The objective of the present invention is to increase reliability in an electronic control device when speculative execution is performed, by reducing the risk of erroneous control by the electronic control device, said erroneous control being due to speculative execution failures (such as failures to predict a future state or failure to complete a control calculation due to the execution of an advanced control calculation) which are generated when speculative execution is performed using limited hardware resources in an electronic control device having a control period restriction. Therefore, this electronic control device, which performs a calculation in accordance with one or more external inputs, and outputs a calculation result by a prescribed time, has one or more first calculation units that perform a calculation using a current input, and one or more second calculation units that perform a calculation using a prior input that been input at a point in time prior to the current input.

### TECHNICAL FIELD

The present invention relates to an electronic control device, and relates to a device which performs a control calculation on the basis of a signal input from various sensors mounted in a control target to the electronic control device and completes a control calculation until a defined timing when a calculation result is output.

### BACKGROUND ART

Conventionally, an electronic control device has been used as a device which controls a control target such as an automatic transmission of a vehicle to track a desired target value. In the electronic control device, there has been used a control called a feed-back control in which a state of the control target is input from various sensors mounted in the control target, and a control calculation is performed by a calculation device such as a microcontroller on the basis of a difference with respect to the target value so as to make the state of the control target approach the control target value. In general, a digital control is used as such a control. In the digital control, the control device is configured on an assumption that the operation is performed along a periodic input/output timing (control period). Therefore, there is a need to observe the control period.

For this reason, it is required that a high-speed control method is applied to the control calculation in order to improve a rapid responsiveness to the target value. As such a high-speed control method, a model prediction control is exemplified. In the model prediction control, the control target is controlled such that a model of the control target is stored as an internal model in the electronic control device, and a future behavior of the control target is predicted using the internal model. It is possible to control the target value with a high tracking property by predicting the future behavior of the control target. On the contrary, there is required a lot of calculation amount, and a longer time taken for the control calculation.

### CITATION LIST

### Patent Literature

PTL 1: Publication of U.S. Pat. No. 4,811,495

### SUMMARY OF INVENTION

### Technical Problem

When the high-speed control described above is applicable to a hydraulic control of the automatic transmission of a vehicle for example, a gear shift can be made more smoothly and a ride quality can be improved. On the other hand, such an advanced control method requires a long calculation time as described above. Therefore, it is difficult to apply the control scheme without any change particularly to the electronic control device having a short control period.

As one of schemes used when the control method requiring a long calculation time is applied to the electronic control device having a short control period, there is a method called speculative execution. The speculative execution is a method to make it possible to secure a long calculation time with respect to an actual calculation time by starting the calculation based on prediction of a future state before an actual input is arrived. Since a timing for starting the calculation can be made earlier up to a timing when a restriction of the control period is satisfied by applying the speculative execution to a control system, the advanced control method can be applied to the electronic control device having a restriction on the control period. On the other hand, the speculative execution has a risk that the prediction may fail since the prediction of the future state is assumed. In a case where the speculative execution is applied to the control, there is a risk that the erroneous control due to the prediction failure may be performed. For example, it is difficult to apply the speculative execution without any change to the electronic control device, such as the electronic control device of a vehicle, for which high reliability and safety are required.

As one of the methods to solve the problem, PTL 1 discloses an example in which the control calculation is performed on all states of a rotation machine (control target) obtainable in the future and a control output is selected on the basis of validity of the calculation result so as to avoid a risk that an inappropriate control is performed on the control target.

On the other hand, a method of comprehensively calculating all the states of the control target obtainable in the future as described above is effective in a case where the number of states obtained from the control target is small. However, since a general control target has a number of states, hardware resources necessary for the comprehensive calculation of all the states expand. Therefore, it is difficult to apply such a method to the general control device from the viewpoint of the hardware resources.

In addition, some of the advanced control methods may require to perform a convergence calculation in which the calculation is repeatedly performed until the calculation result is converged for the purpose of optimization for example. In a case where the convergence calculation is performed, a time taken for the calculation becomes unstable. Therefore, even in a case where the speculative execution succeeds, the calculation may be not completed in the control period, and thus there is a need to prepare a separate countermeasure.

The invention has been made in view of the problems, and an object thereof is to relieve a risk that an electronic control device erroneously performs a control output due to a prediction failure caused when an advanced control using the speculative execution is performed using limited hardware resources, or due to a failure in a control calculation such as incompletion of the control calculation within the control period caused by the convergence calculation, and accordingly to increase reliability when the electronic control device performs the speculative execution.

### Solution to Problem

The above object can be achieved, for example, by a first calculation unit which performs the calculation using a current input from the outside and a second calculation unit which performs the calculation using a prior input that has been input at a point in time prior to the current input.

### Advantageous Effects of Invention

According to the invention, it is possible to perform speculative execution in which a control calculation starts before an actual input value is arrived.

### BRIEF DESCRIPTION OF DRAWINGS

FIG. 1 is a functional block diagram illustrating a configuration of an electronic control device 1 and an automatic transmission (control target) 7 according to a first embodiment of the invention.

FIG. 2 is a timing chart illustrating an operation of the electronic control device 1 according to the first embodiment of the invention, when it pays attention to a specific control output timing.

FIG. 3 is a timing chart illustrating an actual operation of the electronic control device 1 according to the first embodiment of the invention.

FIG. 4 is a functional block diagram illustrating an inner configuration of a second calculation unit 32 in the electronic control device 1 according to the first embodiment of the invention.

FIG. 5 is a functional block diagram illustrating an inner configuration of the automatic transmission 7 according to the first embodiment of the invention.

FIG. 6 is a graph illustrating an operation when the electronic control device 1 controls a solenoid valve (control target) 7 according to the first embodiment of the invention.

FIG. 7 is a table showing evaluation bases when an evaluation unit 4 and a selection unit 5 determine the output of the electronic control device 1 according to a second embodiment of the invention.

FIG. 8 is a functional block diagram illustrating a configuration of the electronic control device 1 and the automatic transmission 7 according to a third embodiment of the invention.

FIG. 9 is a functional block diagram illustrating one of exemplary configurations of the electronic control device 1 and the automatic transmission 7 according to a fourth embodiment of the invention.

FIG. 10 is a functional block diagram illustrating one of exemplary configurations of the electronic control device 1 and the automatic transmission 7 according to the fourth embodiment of the invention.

### DESCRIPTION OF EMBODIMENTS

### First Embodiment

Hereinafter, an electronic control device according to a first embodiment of the invention will be described using the drawings.

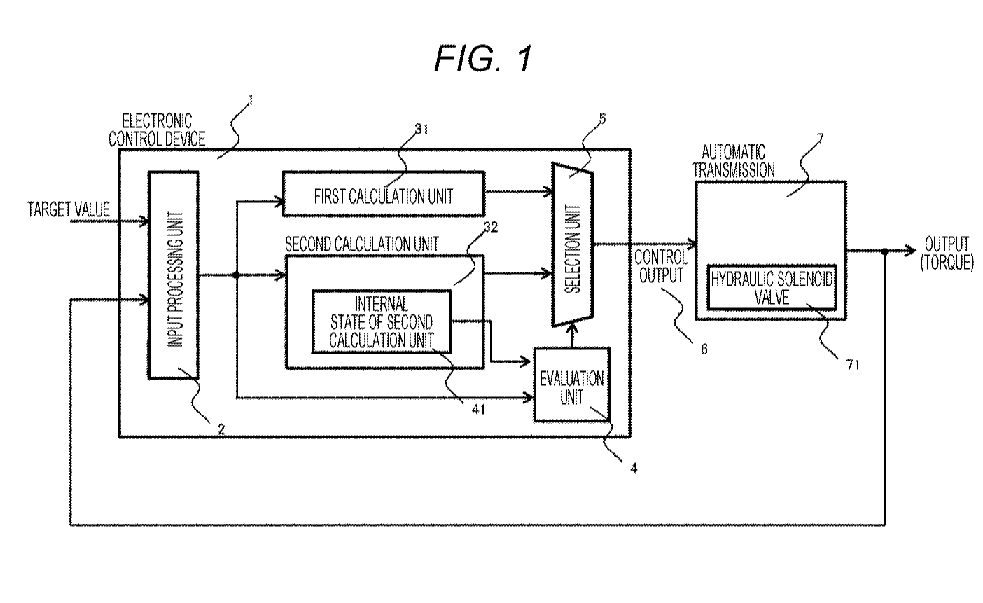

FIG. 1 is a block diagram illustrating a configuration of a control system which is made of an electronic control device 1 and an automatic transmission (control target) 7 according to this embodiment. The electronic control device 1 illustrated in FIG. 1 receives a target value of a torque output in the automatic transmission (control target) 7 and an output torque value calculated on the basis of a value such as a rotation rate detected by a sensor (not illustrated) mounted in the automatic transmission 7 from a host electronic control device (not illustrated), and determines a voltage value (control output) to a hydraulic solenoid valve 71 in the automatic transmission 7. Further, while the actual automatic transmission 71 is configured by a plurality of hydraulic solenoid valves, only a portion related to the hydraulic solenoid valve 71 will be described in this embodiment for the sake of simplicity.

The electronic control device 1 includes an input processing unit 2 which makes the input to the electronic control device 1 processed and output, a first calculation unit 31 and a second calculation unit 32 which perform a control calculation on the basis of the output of the input processing unit 2, an evaluation unit 4 which outputs an evaluation result on the basis of the output of the input processing unit 2 and an internal state 41 of the second calculation unit 32, and a selection unit 5 which receives the evaluation result of the evaluation unit 4 and outputs one of the calculation results of the first calculation unit 31 and the second calculation unit 32 as the electronic control device 1.

Hereinafter, the control performed by the electronic control device 1 will be described.

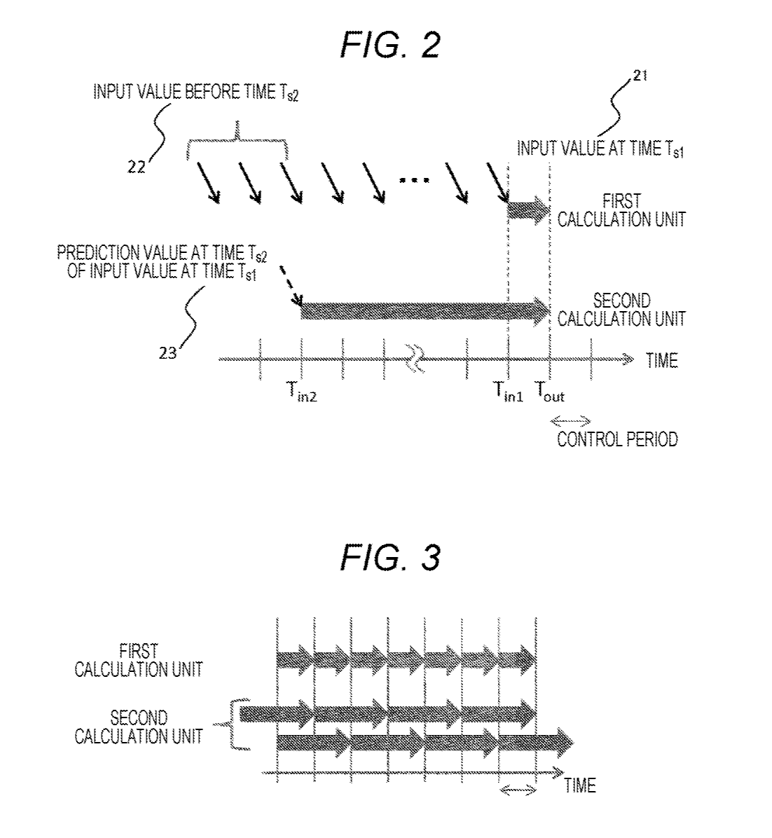

FIG. 2 is a timing chart for describing a procedure of the control calculation necessarily to perform the control output at time Tout using the first calculation unit 31 and the second calculation unit 32 on the basis of the input value until time Tin1. The first calculation unit 31 performs the control calculation within one control period using a MAP control in which an output value with respect to the input value is set in advance, on the basis of an input value 21 at time Tin1, and outputs the calculation result at time Tout. With this regard, the second calculation unit 32 performs the control calculation using a model prediction control on the basis of a prior input value 22 that has been input before time Tin2, and outputs the calculation result at time Tout. The reason why the calculation start time Tin2 of the second control unit 32 is earlier than the calculation start time Tin1 of the first calculation unit is that the control calculation is not possible to be completed within one control period due to the characteristics of the above-described model prediction control, so that the calculation start time is set to be early using speculative execution in order to realize the calculation completion in time Tout. The second calculation unit 32 performing such a calculation has a risk that a prediction in the speculative execution fails as described above so as to fail in the control calculation, and a risk that the calculation is not completed in time Tout because of performing the model prediction control necessary for a convergence calculation. In this embodiment, it is assumed that a variation in calculation time of the convergence calculation becomes sufficiently small with respect to the calculation time assigned to the second calculation unit 32 by performing the speculative execution, and the control calculation is completed within the calculation time assigned to the second calculation unit 32. Only the risk of failure in the control calculation caused by a prediction failure will be considered. Further, the description about that the electronic control device 1 can be used similarly to this embodiment even in a case where the assumption on the convergence calculation is not established will be made in a second embodiment.

On the above-described condition, the second calculation unit 32 predicts the input value at time Tin1, and performs the speculative execution in which the control calculation starts early. In this embodiment, it is assumed that the calculation time assigned to the second calculation unit 32 is configured of two control periods by performing the speculative execution for the sake of simply explanation.

Since the second calculation unit 32 is set to perform the control calculation in two control periods, the control calculation for performing the control output at time Tout is started at time Tin2 in one control period further earlier from time Tin1. The second calculation unit 32 performs the speculative execution in which the input value 21 at time Tin1 necessary for performing the control calculation is predicted at time Tin2 and calculated on the basis of the prior input value 22 that has been input to the electronic control device 1 until time Tin2 when the calculation starts. Herein, the input value 21 at time Tin1 is similarly predicted using the prior input value that has been input before two control periods (that is, time Tin2 and one control period before that time) for the sake of simplicity.

The evaluation unit 4 makes an evaluation on the calculation result of the second calculation unit 32 which performs the calculation as described above. The content of the evaluation is a success or failure of the speculative execution. The evaluation unit 4 outputs, to the selection 5, a signal to select the calculation result of the second calculation unit 32 in a case where the second calculation unit 32 succeeds in the speculative execution, and selects the calculation result of the first calculation unit 31 in a case of failing in the speculative execution. The selection unit 5 selects the calculation result of the first calculation unit 31 or the second calculation unit 32 on the basis of the signal, and outputs the signal as a control output 6 of the electronic control device 1. Further, the success or failure of the speculative execution can be determined on the basis of whether a prediction value 23, which is stored as the internal state 41 in the second calculation unit 32 and obtained by predicting the input value 21 at time Tin1 using the input value before time Ts2, falls within a certain threshold value with respect to the input value 11.

In practice, since performing the control output every control period, the electronic control device 1 compares the calculation results of the first calculation unit 31 and the second calculation unit 32 every control period as illustrated in a timing chart of FIG. 3, and selects the control output 6 of the electronic control device 1. Therefore, the electronic control device 1 is required to have one first calculation unit 31 and calculation units in the second calculation unit 32 as many as the calculation times assigned to the second calculation unit. Since the second calculation unit 32 in this embodiment performs the control calculation in two control periods, the second calculation unit 32 includes two calculation units in order for the electronic control device 1 to output the control output 6 every control period, and the two calculation units necessarily perform the control output alternately.

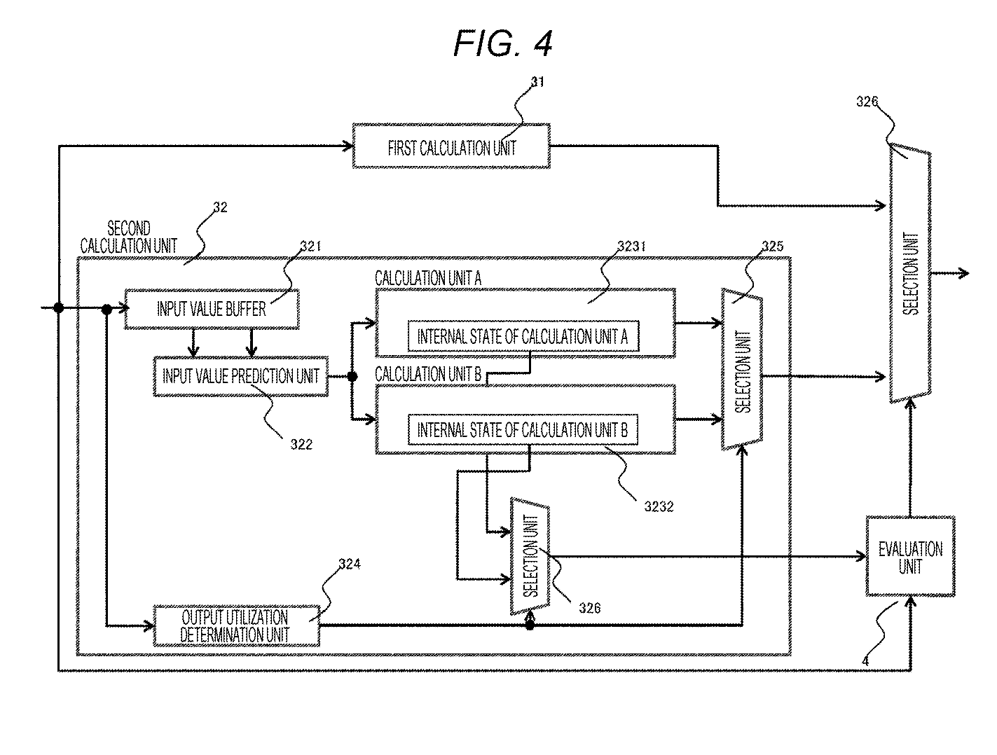

FIG. 4 is a diagram illustrating an inner configuration of the second calculation unit 32. The second calculation unit 32 is configured by an input value buffer 321 which stores and outputs two prior input values 22 that have been input to the electronic control device 1, an input value prediction unit 322 which calculates the prediction value 23 on the basis of the prior input value 22 stored in the input value buffer 321, two calculation units A 3231 and B 3232, each of which outputs a result obtained by the control calculation on the basis of the prediction value 23 output from the input value prediction unit 322, an output utilization determination unit 324 which determines any one of the calculation units A 3231 and B 3232 to perform the outputting in each control period, and makes an output, a selection unit 325 which selects the calculation unit A 3231 or B 3232 which performs the control output on the basis of the output of the output utilization determination unit 324, and makes an output to the selection unit 5, and a selection unit 326 which selects the internal states of the calculation units A 3231 and B 3232 which perform the control output on the basis of the output of the output utilization determination unit 324, and outputs the selected state to the evaluation unit 4. A future input prediction value 23 for determining the success or failure of the above-described speculative execution is assumed to be stored in the calculation units A 3231 and B 3232, and to be output to the evaluation unit 4 by the selection unit 326.

Further, while the calculation time assigned to the speculative execution is assumed to be two control periods in this embodiment, the same configuration may be applied even in a case where two or more control periods are required. In general, in a case where the calculation time in the second calculation unit 32 becomes N control periods, the number of calculation units mounted in the second calculation unit 32 is “N”, and accordingly the number of inputs of the selection units 324 and 325 changes in accordance therewith. In addition, even the number of prior input values which are stored in the past by the input value buffer 321 storing the prior input value 22 that has been input to the input value prediction unit 322 may arbitrarily change in accordance with the installation of the input value prediction unit 322.

The operation of the automatic transmission 7 controlled by the electronic control device 1 which performs the above-described control will be described in the following.

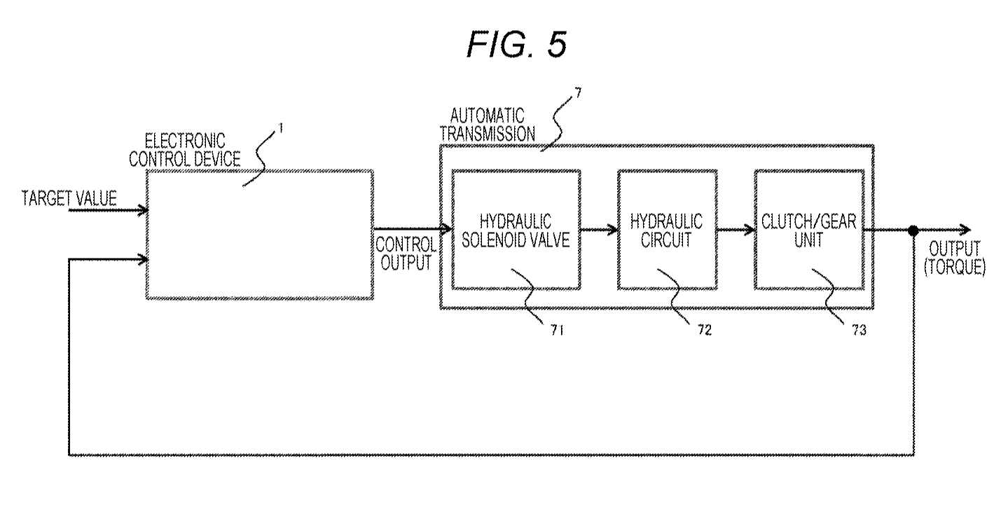

FIG. 5 illustrates a configuration of the automatic transmission 7 which is a control target in this embodiment. Further, for the sake of simplicity, the automatic transmission 7 is provided with one hydraulic solenoid valve 71 which is driven by the voltage value (control output) of the electronic control device 1, a hydraulic circuit unit 72 which is controlled by the hydraulic solenoid valve 71, and a mechanism unit 73 which outputs torque to make an actual gear shift while being controlled by the hydraulic circuit unit 72.

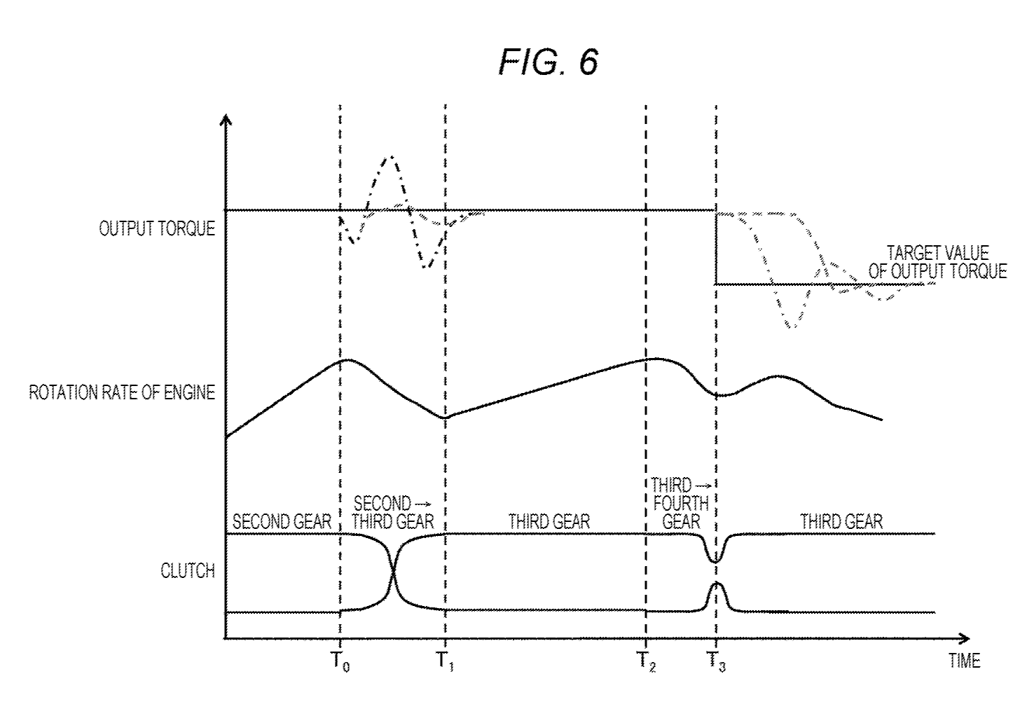

FIG. 6 is a graph illustrating a change at the time of gear shift (up shift) of the output torque of the automatic transmission 7 when the solenoid valve in the automatic transmission 7 is controlled by the electronic control device 1 according to the invention. A target value of the output torque is depicted by a solid line, the output torque value in a case where the control is performed using the calculation result of the first calculation unit is depicted by a chain line, and the output torque value in a case where the control is performed using the calculation result of the second calculation unit is depicted by a dotted line. In FIG. 6, the description will be made about a behavior of the output torque of the automatic transmission 7 when the gear shift starts at time T0 and is completed at time T1, and the gear shift restarts at time T2 and is stopped by changing an opening of an accelerator at time T3.

While the automatic transmission 7 starts to make a gear shift at time T0, the target value of the output torque does not change. Therefore, the speculative execution in the second calculation unit is able to easily succeed. In this case, since the calculation result of the second calculation unit 32 is used as the output of the electronic control device 1 in a period from time T0 to time T1, the output torque shows a behavior depicted by a broken line, and a smooth gear shift can be made in which a shock of the gear shift is less than that in the conventional control. However, when the gear shift is made at the second time after time T2, the target value of the output torque is steeply changed at time T3, and thus the prediction value 23 in the second calculation unit 32 is differentiated from the actual input value 21. Therefore, it is not possible to perform the control with a good tracking property since the control is made to follow the target value different from the prediction based on the prior input value 22 as depicted by a broken line together with the actual target value. At this time, the evaluation unit 4 determines that the speculative execution fails, and the selection unit 5 selects the calculation result of the first calculation unit 31 as the control output of the electronic control device 1. Therefore, it is possible to prevent an operation which is unexpected by a designer or a driver.

Further, the first calculation unit 31 and the second calculation unit 32 which perform the control calculation in this embodiment are configured by one per each control output timing, but the invention is not limited thereto. In other words, a plurality of calculation units are mounted in the second calculation unit 32, and the calculation is performed on a plurality of future input prediction values 23, so that it is possible to improve a success rate of the speculative execution.

In addition, while the first calculation unit of the MAP control is mounted in this embodiment, the same operational effect described in the embodiment can be achieved even when a PID control is mounted for example.

In addition, the above embodiment has been described about an example in which the prediction value 23 used in the calculation by the second calculation unit 32 is calculated by the input value prediction unit 322 in the second calculation unit, and used by the calculation unit A 3231 and the calculation unit B 3232. However, the prediction value 23 may be given to the second calculation unit from a host electronic control device (not illustrated). With such a configuration, the same operational effect as that described in the embodiment can be obtained.

Further, various modifications described above may be applied alone, or may be applied in combination.

The above-described embodiment and various modifications are described as merely exemplary, and the invention is not limited to these contents as long as the features of the invention are not spoiled.

### Second Embodiment

Next, an electronic control device according to a second embodiment of the invention will be described using the drawings.

In this embodiment, the hardware configuration is the same as that of the first embodiment, and the description will be made about that the electronic control device 1 can be increased in reliability by determining the calculation failure of the second calculation unit 32 and using the first calculation unit 31 even in a case where the assumption of the first embodiment is not established in which the variation in calculation time of the convergence calculation performed by the second calculation unit 32 is sufficiently small to be negligible with respect to the calculation time assigned to the second calculation unit 32.

Hereinafter, an operation of the electronic control device 1 in this embodiment will be described.

Since an influence of the convergence calculation is not negligible in this embodiment while the calculation starts before two control periods in the first embodiment described above, there may be a case where the second calculation unit 32 does not complete the calculation until time Tout at which the control output in FIG. 2 is performed. When the convergence calculation is performed, there is a predetermined condition that the calculation is ended, and the calculation is repeatedly performed until the calculation end condition is satisfied. For example, in a case where the calculation is performed in the second calculation unit 32 using an algorithm such as the steepest descent method, the input is updated using a unique recursion formula, and the calculation is ended when a gradient of an evaluation function is less than a reference value. The evaluation unit 4 can determine whether the calculation of the second calculation unit 32 is ended by outputting a flag indicating the calculation end to the evaluation unit 4.

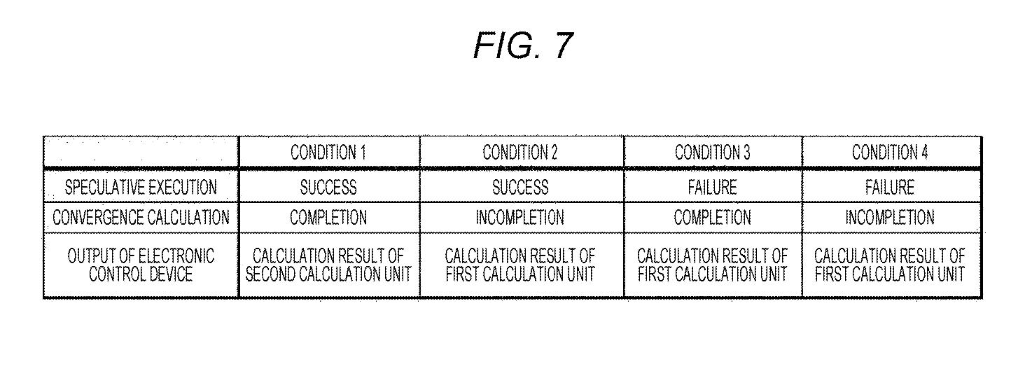

The evaluation unit 4 determines the calculation end of the second calculation unit in addition to the determination on the success or failure of the speculative execution in the first embodiment. The evaluation unit 4 sets the calculation result of the second calculation unit 32 as the control output of the electronic control device 1 using the selection unit 5 when the speculative execution succeeds and the convergence calculation is ended as Condition 1 denoted in FIG. 7, and sets the calculation result of the first calculation unit 31 in other cases.

The above-described operation of the electronic control device 1 in this embodiment is different from the first embodiment. According to this embodiment, even in a case where the variation in calculation time when the convergence calculation is performed is not negligible while the speculative execution is performed in the second calculation unit 32 described in the first embodiment, it is possible to evaluate validity of the calculation result in the second calculation unit 32 using the evaluation unit 4. Therefore, it is possible to perform the same control as that of the first embodiment with respect to the automatic transmission (control target) 7.

### Third Embodiment

Next, an electronic control device according to a third embodiment of the invention will be described using the drawing.

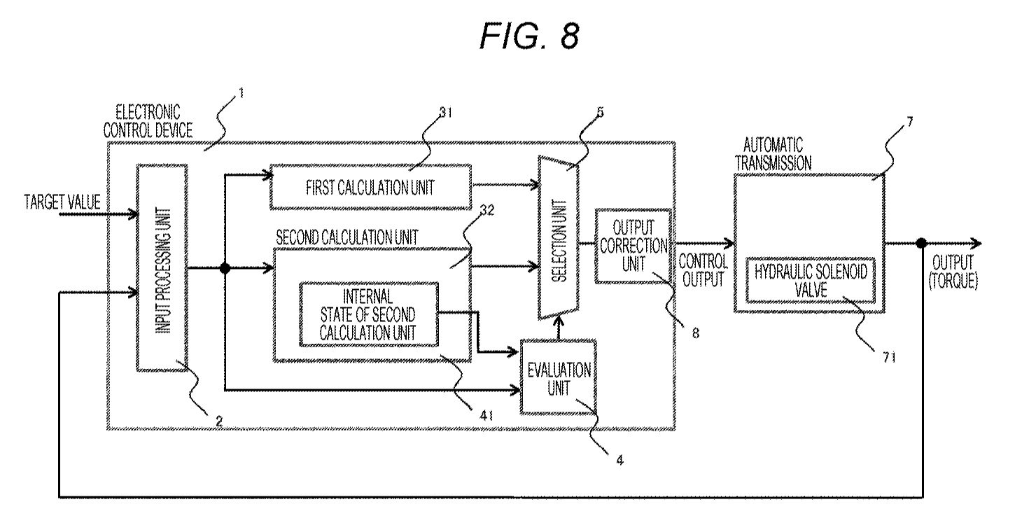

FIG. 8 is a block diagram illustrating a configuration of a control system which is made of the electronic control device 1 in this embodiment and the automatic transmission (control target) 7. A difference in the hardware configuration between this embodiment and the first embodiment is that an output correction unit 9 is added which receives the output of the selection unit 5 in the electronic control device 1 and outputs the control output of the electronic control device 1.

Hereinafter, an operation of the first calculation unit 31 in this embodiment will be described.

In a case where the calculation result of the second calculation unit 32 is failure in the first and second embodiments, the calculation result of the first calculation unit 31 is output as the control output of the electronic control device 1 by the selection unit 5. At this time, since the first calculation unit 31 and the second calculation unit 32 are different in the tracking property with respect to the control goal, the values of the control output of the electronic control device 1 are deviated between the previous calculation result (control output) of the second calculation unit 32 of the electronic control device 1 and the next calculation result of the first calculation unit 31. Therefore, there is a possibility that the behavior of the automatic transmission (control target) 7 becomes unstable. In order to prevent such an instability, it is considered to add a function of correcting the control output of the electronic control device 1 to the selection unit 5. In this embodiment, it is desirable that the control target cause a smooth change in the output. Therefore, it is desirable that the outputs of the first calculation unit 31 and the second calculation unit 32 be not instantaneously changed with respect to the control output of the electronic control device 1. As an example of installation, a filter circuit is configured in the output correction unit 8 to suppress the instantaneous change of the output, so that it is possible to alleviate a risk that the control target 7 becomes unstable due to a steep change of the control output value of the electronic control device 1.

### Fourth Embodiment

Next, an electronic control device according to a fourth embodiment of the invention will be described using the drawings.

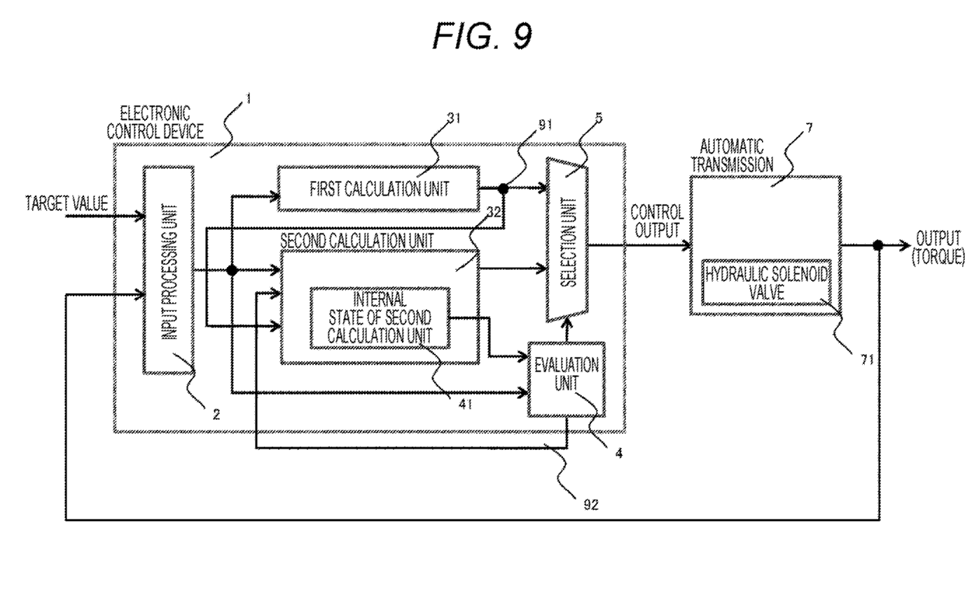

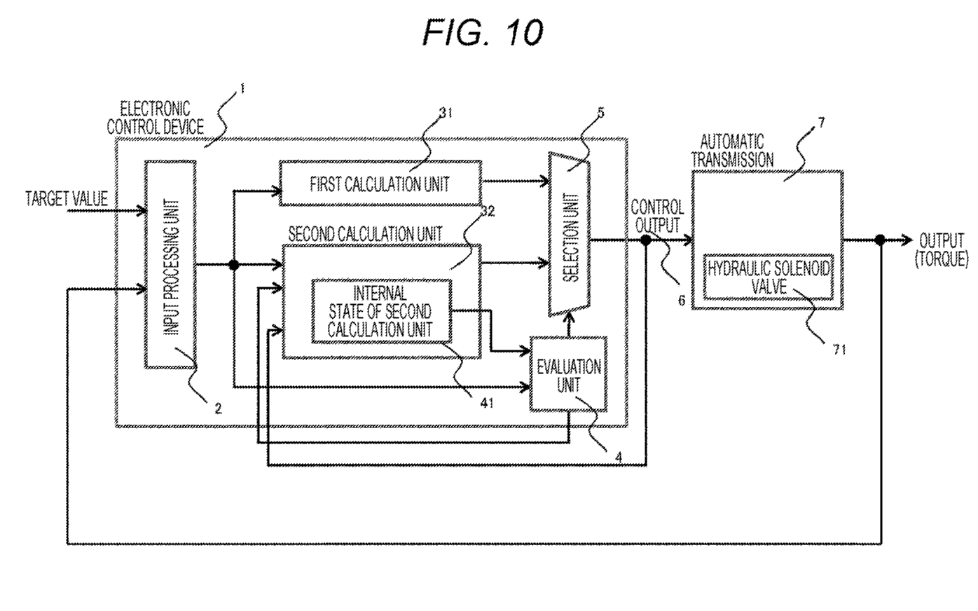

FIGS. 9 and 10 are block diagrams illustrating a configuration of a control system which is made of the electronic control device 1 in this embodiment and the automatic transmission (control target) 7. The hardware configuration of this embodiment is different from that of the first embodiment in that the evaluation result of the calculation result of the second calculation unit performed by the evaluation unit 4 is added with the calculation result of the first calculation unit 31 as the input value with respect to the second calculation unit 32 in the electronic control device 1 (FIG. 9), or the control output of the electronic control device 1 is added (FIG. 10). The mounting methods of FIGS. 9 and 10 are different in the hardware configuration, but have the same effect in functionality.

Hereinafter, an operation of the second calculation unit 32 in this embodiment will be described. First, the operation of the second calculation unit 32, when the output of the second calculation unit 32 is used as the output of the electronic control device 1 by the evaluation unit 4 and the selection unit 5 (that is in a case where the calculation result of the first calculation unit 31 is not used as the control output of the electronic control device 1), is the same as that of the first embodiment.

With this regard, in a case where the second calculation unit 32 fails in the speculative execution, or the convergence calculation is incomplete, the calculation result of the first calculation unit 31 is used as the control output of the electronic control device 1 by the evaluation unit 4 and the selection unit 5. At this time, the second calculation unit 32 in the first embodiment uses only the control target value from a host controller (not illustrated) input to the electronic control device 1 and the output of the automatic transmission (control target) 7 to recover the control calculation. At this time, since the automatic transmission 7 is controlled not by the second calculation unit 32 but by the first control unit 31, the output of the electronic control device 1 is not possible to be obtained from the second calculation unit 32. Therefore, it is difficult to estimate the internal state of the automatic transmission (control target) 7. As a result, the internal state of the control target is not possible to be estimated until the state of the control target becomes stable about the control target value, and it is considered that a failing period of the speculative execution is lengthened more than necessary. In this embodiment, when the calculation result of the first calculation unit 31 is output as a result of the evaluation unit 4, the estimation and the calculation of the internal state of the control target becomes possible in the second calculation unit 32 by confirming the output value of the first calculation unit 31. Further, it is possible to shorten a time taken until that the second calculation unit 32 is reused in the first embodiment.

### REFERENCE SIGNS LIST

1 electronic control device
2 input processing unit in electronic control device
21 input value at time Tin1 to electronic control device
22 plurality of input values at time before time Tin2 to electronic control device
23 prediction value of input value at time Tin1 at time Tin2
31 first calculation unit
32 second calculation unit
321 input value buffer to second control unit
322 input value prediction unit which predicts future input value on the basis of input value buffer
3231 calculation unit A mounted in second calculation unit
3232 calculation unit B mounted in second calculation unit
324 selection unit which selects calculation unit for performing output every control period from among calculation units in second calculation unit
325 selection unit which selects internal state of calculation unit for performing output every control period from among internal states of calculation unit in second calculation unit
326 output utilization determination unit which determines calculation unit for performing output every control period from among internal states of plurality of calculation units in second calculation unit
4 evaluation unit
41 internal state of second calculation unit
5 selection unit
6 correction unit which corrects steep variation in time of output of electronic control device
7 automatic transmission which is control target
71 hydraulic solenoid valve in automatic transmission
72 hydraulic circuit in automatic transmission
73 machinery such as clutch and gear in automatic transmission

1. An electronic control device that performs a calculation according to one or more external inputs and outputs a calculation result until a predetermined time, comprising:
one or more first calculation units that perform a calculation using a current input value; and
one or more second calculation units that perform a calculation using a prior input value that has been input at a point in time prior to the current input.

2. The electronic control device according to claim 1, further comprising:
an evaluation unit that evaluates a calculation result of the second calculation unit on the basis of the current input value and an internal state of the second calculation unit; and
a selection unit that selects one of a calculation result of the first calculation unit and a calculation result of the second calculation unit on the basis of an evaluation result of the evaluation unit, and outputs the calculation result.

3. The electronic control device according to claim 2,
wherein a value calculated on the basis of the prior input is used as an internal state of the second calculation unit.

4. The electronic control device according to claim 3,
wherein the calculation is repeatedly performed until an end condition is satisfied in the second calculation unit, and a determined result of the end condition is used as the internal state of the second calculation unit.

5. The electronic control device according to claim 3, further comprising:
a correction unit that is between an output portion of the selection unit and an output portion of the electronic control device to suppress a variation in time of the output.

6. The electronic control device according to claim 3,
wherein the calculation result of the first calculation unit and the evaluation result of the evaluation unit are used as inputs of the second calculation unit.

7. The electronic control device according to claim 3,
wherein a control output of the electronic control device is used as an input to the second calculation unit.
